(19) United States
(12) Patent Application Publication
(10) Pub. No.: US 2003/0211451 A1
(43) Pub. Date: Nov. 13, 2003

(54) System and method for distance learning of systems knowledge and integrated procedures using a real-time, full-scope simulation

(75) Inventors: Richard Bergeron, Ste.Dorothee-Laval (CA); Bernard De Champlain, Montreal (CA)

Correspondence Address: OGILVY RENAULT, 1981 MCGILL COLLEGE AVENUE, SUITE 1600, MONTREAL, QC, H3A2Y3, CA

(73) Assignee: CAE Inc., Saint Laurent (CA)

(21) Appl. No.: 10/139,219

(22) Filed: May 7, 2002

(51) Int. Cl. G09B 7/00

(52) U.S. Cl. 434/362

(57) ABSTRACT

A system and method for distance learning of systems knowledge and integrated procedures using a real-time, full-scope simulation. The system includes a server component with at least one simulation server, and a client computer with a run-time engine. The simulation runs on the server component and conditions of the simulation that affect the user interface are communicated to the client computer and displayed to the student, to reinforce and promote systems knowledge and procedure learning. Courseware can also be used to enhance the learning experience.

### CROSS-REFERENCE TO RELATED APPLICATIONS

This is the first application filed for the present invention.

### TECHNICAL FIELD

The invention relates in general to computer-based training and, in particular, to a system and method for distance learning of systems knowledge and integrated procedures using a real-time, full-scope simulation.

### BACKGROUND OF THE INVENTION

Real-time, full-scope simulator systems are used for training those who operate or maintain expensive, complex and/or hazardous systems or machines to reduce the risk of losing valuable equipment, lower training costs, and to ensure public safety. A real-time, full-scope simulator integrates models of multiple (different) subsystems in order to produce a highly accurate reproduction of the responses of a complex real system. Commonly simulated systems include jet aircraft, submarines, ships, military equipment, nuclear power plants, electrical distribution grids, and the like. The full-scope simulators themselves are complex systems that are expensive to construct, and generally require a large, protected operating space. Full-scope simulators typically provide training for a single student, or a small group of students, at a time. Since full-scope simulators are large, complex systems they are typically housed in a training center and students are compelled to travel to the center for their training. Many full-scope simulator systems replicate an entire environment that an operator experiences in the real system, including replicas of the control equipment (cockpit for an aircraft pilot, for example), motion sub-systems, visual sub-systems and extensive software models used to precisely simulate behaviors of the real system. Full-scope simulators are very expensive to construct and maintain, and their use is consequently limited to a reasonably small number of applications.

There is an extensive library of computer software models used in full-scope simulators. These computer software models have typically been developed for specific simulated systems over the past 20 years. These computer software models were not developed or designed for mass distribution to a large number of remote users, but can be re-hosted to run on current desktop computer platforms. Similarly, an extensive library of courseware has been developed to supplement the full-scope simulator. This courseware was typically designed to be used as an instructional aid.

It is well known that a principal component of the training of professional operators and maintenance personnel involves the learning of systems knowledge and integrated procedures. This is true of all complex systems for which simulators have been created. While the systems knowledge and integrated procedures are most quickly and easily learned under the supervision of a qualified instructor using a full-scope simulator, it has been established that systems knowledge and integrated procedures are also rapidly and efficiently acquired using self-paced courseware that runs over a real-time, full-scope simulation. This reduces training cost and permits more students to be trained concurrently.

The growth in demand for highly trained professionals, in conjunction with improvements in technologies for the mass delivery of digital information, such as the Internet, has made it highly desirable to be able to provide training programs that permit professionals to learn systems knowledge and integrated procedures from remote locations. Such programs are generally referred to as “distance learning programs”. Distance learning reduces training costs and permits more students to receive training concurrently.

Computer-based training systems used for distance learning are well known. For example, U.S. Pat. No. 6,371,765 to Wall et al., entitled INTERACTIVE COMPUTER-BASED TRAINING SYSTEM AND METHOD, issued on Apr. 16, 2002. Wall et al. describe an interactive computer-based training (ICBT) system and method operable over a computer network for training students. The ICBT system includes a hardware simulator for emulating various hardware conditions associated with a piece of equipment on which the student is to receive interactive training. A software simulator provided as a command inference engine is coupled to the hardware simulator. The software simulator permits the student to interactively interrogate the emulated piece of equipment for its software functionality. However, Wall et al. fail to teach any computer methods or network architecture that would permit distance learning of systems knowledge and integrated procedures training on real-time, full-scope simulation, for complex systems such as a simulator for a jet aircraft, a submarine, a nuclear power plant, or the like.

There is therefore a need for a system for distance learning of systems knowledge and integrated procedures on real-time, full-scope simulations. There is also a need for such a system to permit re-use of legacy computer software models and courseware.

### SUMMARY OF THE INVENTION

It is an object of the present invention to provide a system for distance learning of systems knowledge and integrated procedures on real-time simulations.

It is a further object of the invention to provide a system and method for distance learning that permits reuse of legacy computer software models and courseware for real-time, full-scope simulations.

The invention therefore provides a system for enabling distance learning that permits a student to use a remote client computer connected to a network to learn systems knowledge and integrated procedures using self-paced courseware. The system comprises at least one simulation server adapted to instantiate an instance of a real-time, full-scope simulation for a learning session initiated by the student. The simulation server is adapted to receive, from a run time engine (RTE) of the remote client computer, inputs generated by an interaction of the student with the courseware during the learning session. The simulation server is also adapted to pass the inputs to the instance, and further adapted to receive outputs from the instance and to pass the outputs to the RTE, which updates a graphical user interface displayed by the remote client computer to reflect a condition of the instance, while the student trains using self-paced courseware.

The invention further provides a method of providing distance learning to a student having remote client computer connected to a network. The method comprises a step of providing a server component connected to the network to permit the student to initiate a learning session in which self-paced courseware is used for the purpose of learning systems knowledge and integrated procedures associated with a complex system. The method further comprises a step of adapting a real-time, full-scope simulation for simulating the complex system to instantiate an instance of the simulation for the learning session. The method also comprises a step of providing an interface between the instance of the simulation and the courseware running on the remote client computer, to permit a graphical user interface displayed to the student while the courseware runs on the remote client computer to be dynamically updated to reflect a condition of the instance of the simulation.

Advantageously, the server component of the system is connected to the Internet, and a worldwide web interface is provided to permit the student to initiate the learning session through the Internet.

The invention therefore reduces the requirement for instructors for teaching complex system knowledge and integrated procedures to students learning to operate and/or maintain a complex system for which a full-scope simulation is available. The invention also reduces the cost of traveling to and from training centers and simplifies the scheduling of the training activities by enabling it anywhere and anytime over a network. The system can be used to train airline pilots, and operators for ships, submarines, military vehicles, nuclear power plant operators, and any other complex system for which a real-time, full-scope simulation is available, remotely such that the students do not have to travel to a training center and can conduct their own training in a self-paced manner.

### BRIEF DESCRIPTION OF THE DRAWINGS

Further features and advantages of the invention will become apparent from the following detailed description, taken in combination with the appended drawings, in which:

FIG. 1 is a schematic diagram of a system in accordance with the invention for distance learning of systems knowledge and integrated procedures using a real-time, full-scope simulation;

FIG. 2 is a flowchart of a process illustrating an overview of how the system in accordance with the invention provides distance learning to students;

FIG. 3 is a schematic diagram of selected components of a simulation server shown in FIG. 1;

FIG. 4 is a flowchart illustrating a method in accordance with the invention of regulating data transmission between an instance of a simulation server and a remote client computer;

FIG. 5 is a diagram of a client computer shown in FIG. 1; and

FIG. 6 is a flowchart of a method in accordance with the invention of screening student inputs to the simulation server.

It will be noted that throughout the appended drawings, like features are identified by like reference numerals.

### DETAILED DESCRIPTION OF THE PREFERRED EMBODIMENT

The invention enables distance learning using courseware that runs over a real-time, full-scope simulation. A basic premise of the invention is to de-couple the student interface from the simulation computer software models, so that the simulation runs on at least one central server, while the user interface runs on a remote client computer. This permits a student to learn systems knowledge and integrated procedures using courseware accessed remotely through a network, such as the Internet.

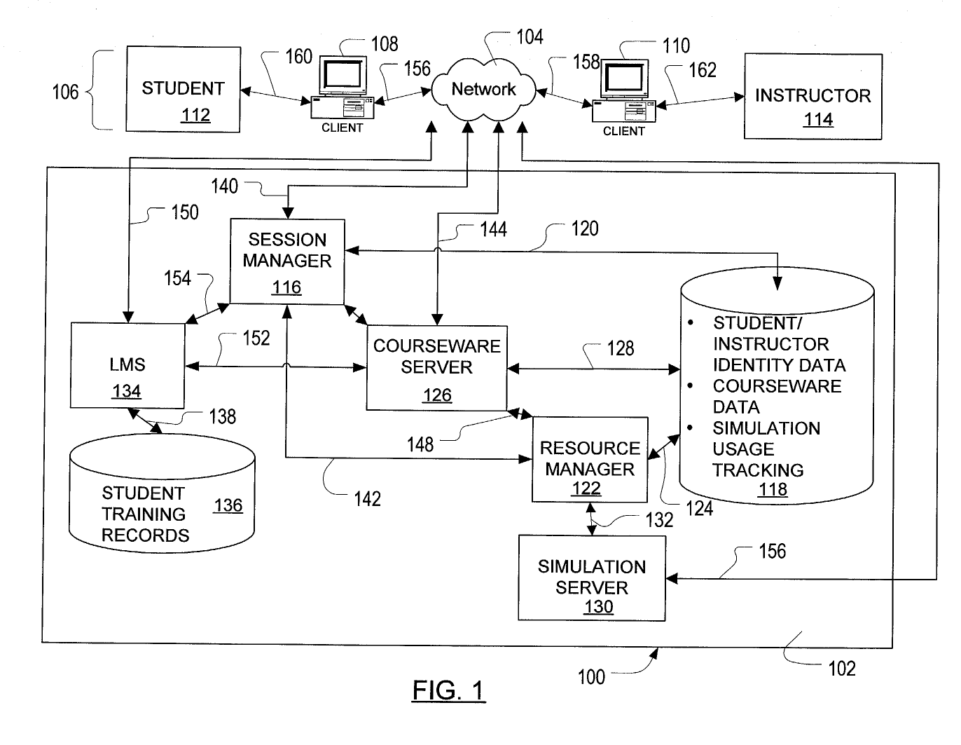

FIG. 1 is a schematic diagram of one embodiment of a system 100 in accordance with the invention. The system 100 includes a server side 102 adapted to serve courseware and simulation services through a network 104 to a client side 106, which includes a plurality of client computers 108, 110. The network 104 may be any network that supports client/server protocols, including a local area network (LAN); a wide area network (WAN); a metropolitan area network (MAN); an Intranet; or, the Internet. The client computers 108, 110 are used by students 112 and instructors 114 for distance learning of systems knowledge and integrated procedures using a real-time, full-scope simulation, as will be explained below in detail. While the explanation below will relate to a single student or instructor accessing a single instance of the simulation, anyone familiar with the art will recognize that, with little modification, the disclosed invention could allow for multiple participants to share a simulation instance in any one of many configurations so as to permit collaborative interaction amongst the participants. Similarly, courseware could be designed to facilitate distance learning of systems knowledge and integrated procedures by a group.

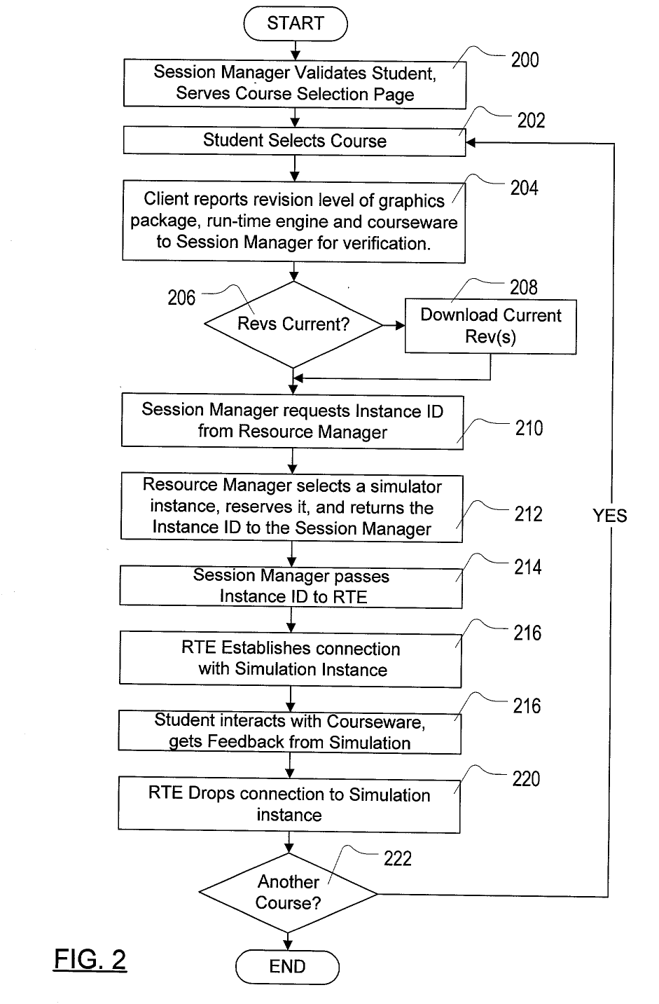

The server side 102 includes a session manager 116 which in this implementation of the system 100 provides a front end to the server side 102 of the system 100. The session manager 116 is coupled to a system database 118 by a bi-directional communications connection 120. The session manager 116 provides the gateway for distance learning sessions and serves up introductory pages to clients 108, 110 as will be described below with reference to FIG. 2. The server side 102 also includes a resource manager 122, which is responsible for managing server side 102 resources. The resource manager 122 is likewise coupled to the system database 118 by a bi-directional communications connection 124 that permits the resource manager to maintain and update simulation usage and tracking information stored on the system database 118, as will likewise be described below with reference to FIG. 2.

A courseware server 126 is coupled to the system database 118 by a bi-directional communications connection 128. The courseware server 126 is responsible for serving courseware stored on the system database 118 to client computers 108, 110, as required. The server side 102 also includes at least one simulation server(s) 130. The simulation server(s) 130 provide real-time, full-scope simulations of complex systems that enable the distance learning of systems knowledge and integrated procedures, in accordance with the invention. The simulation server(s) 130 are coupled to the resource manager 122 by a bi-directional communications connection 132. As will be explained below with reference to FIG. 2, the resource manager 122 manages simulation server(s) 130 resources. In order to optimize efficiency, the simulation server(s) 130 are preferably provisioned with a direct connection 156 to the network 104, as will also be explained below with reference to FIG. 2.

The system 100 also optionally includes a learning management system (LMS) 134 which is coupled to a student training records database 136 by a bi-directional communications connection 138. The optional LMS 134 may alternatively serve as a front end for the server side 102, in which case it is provided with a bi-directional communications connection 150 with a network 104 and a bi-directional communications connection 154 with the session manager 116. LMS 134 is also connected by a bi-directional communications connection 152 to the courseware server 126. If provided, the LMS 134 maintains student training records 136, which are used to track student progress and store student evaluations. The LMS 134 may also be configured to periodically report student progress and evaluations to interested parties (not shown), such as student employers or educational institutions.

On the client side 106, the respective clients 108, 110 are connected to the network 104 by a suitable connection 156, 158, which may be, for example, a dial-up connection or a digital services subscriber line (DSL) connection to their respective Internet Service Provider where the case may be, or the like. The student 112 interacts with the client computer 108, as schematically illustrated at 160, using an input device such as a mouse, joystick, touch-sensitive pad, track ball, or any other device that enables the student 112 to respond to and interact with the client computer 108. The instructor 114 likewise interacts with client computer 110, as illustrated at 162, using any one of the input devices noted above.

FIG. 2 is a flow chart illustrating an overview of a learning session practised using the system 100 shown in FIG. 1. The process begins when the student 112 attempts a log-on to the server side 102 of system 100. When the session manager 116 detects the log-on request, it serves a log-on screen, for example, which permits the student 112 to input identity information. Session manager 116 validates the rights of the student 112 to use the system. If the student 112 is a registered user, as determined by the session manager 116 using student/instructor identity data stored in the system database 118, the session manager serves a course selection page (step 200) to the student 112. The session manager 116 retrieves the course selection page from the system database 118. The course selection page may be generated using personal settings associated with the student identity stored in the system database 118. This permits course selection to be controlled so that students are presented courses based on any one of their organization, registration type and skill level, etc.

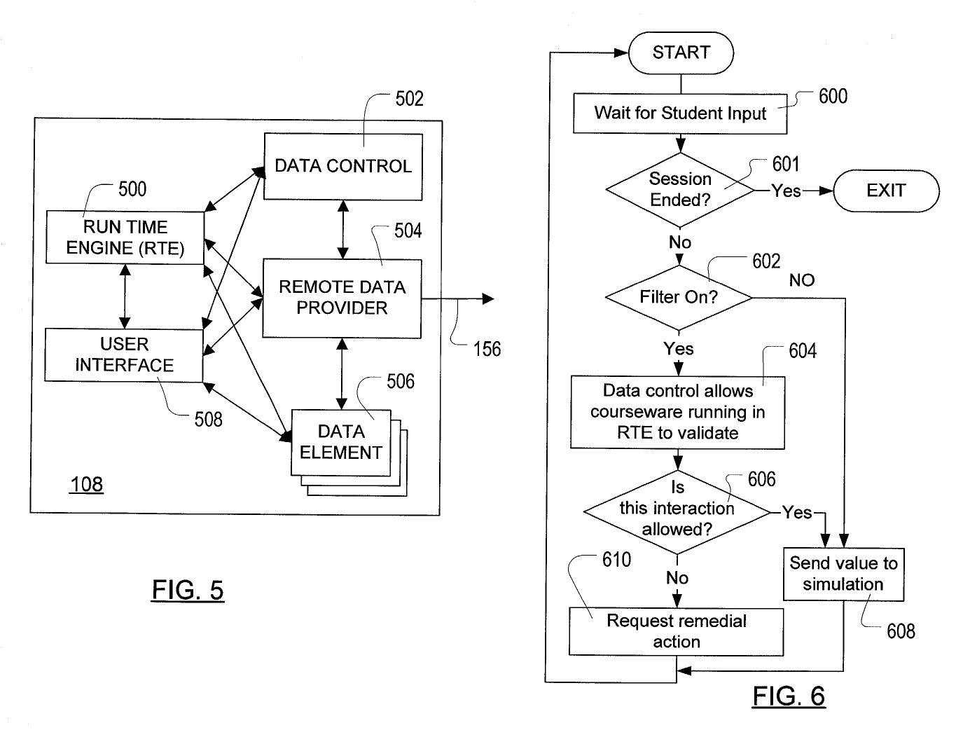

After the student 112 has selected the course (step 202), the client computer 108 reports a revision level of a graphics package used to display a graphical user interface for displaying complex system simulations and courseware in accordance with the invention. The client computer 108 also reports a revision level of a runtime engine (RTE) 500 (see FIG. 5) and courseware related to the selected course to the session manager for verification. The session manager 116 determines (step 206) whether each of the respective revisions are current (step 206). If any of the revisions are not current revisions, or if any of the necessary client software has not yet been downloaded, the session manager instructs the client computer to download the required revisions (step 208). It should be noted that the courseware is not necessarily stored on the client computer 108, in which case the session manager 116 sends a request to the courseware server 126 to have the client computer download the required courseware in step 208.

After any required downloads to the client computer 108 are completed, the session manager 116 sends a request via bi-directional communications connection 142 to the resource manager 122 to obtain an instance ID of an available instance of the requested simulation server 130 (step 210). The resource manager 122 selects a simulation instance and reserves it. Any suitable selection algorithm can be used. Normally an operating simulation is selected, if available. The resource manager 122 informs the simulation server 130 of the reserved instance using bi-directional communications connection 132. The resource manager 122 then returns the instance ID (an Internet Protocol address or a universal resource locator (URL), for example) to the session manager 116 (step 212). In step 214, the session manager passes the instance identification to the run-time engine (RTE) 500. The RTE 500 establishes a connection with the simulation instance (step 216) via the simulation server 130 and direct connection 156 to the network 104. This enhances efficiency by permitting data to be passed directly between the client computer 108 and the instance of the simulation server 130. Subsequently, the courseware launches the course and the student 112 interacts with the courseware (step 216). During interaction, the student 112 receives feedback from the simulation instance. That feedback updates interactive high-resolution graphical representations of the simulated system, which are displayed by the client computer 108. Consequently, the student actions are reflected in the behaviour of the full-scope simulation of the complex system. Once the student 112 has completed the course, the RTE 500 drops the connection with the simulation instance (step 220). The student then selects another course (step 222) or ends the session. If another course is selected, the process returns to step 202 and steps 204-220 are reiterated.

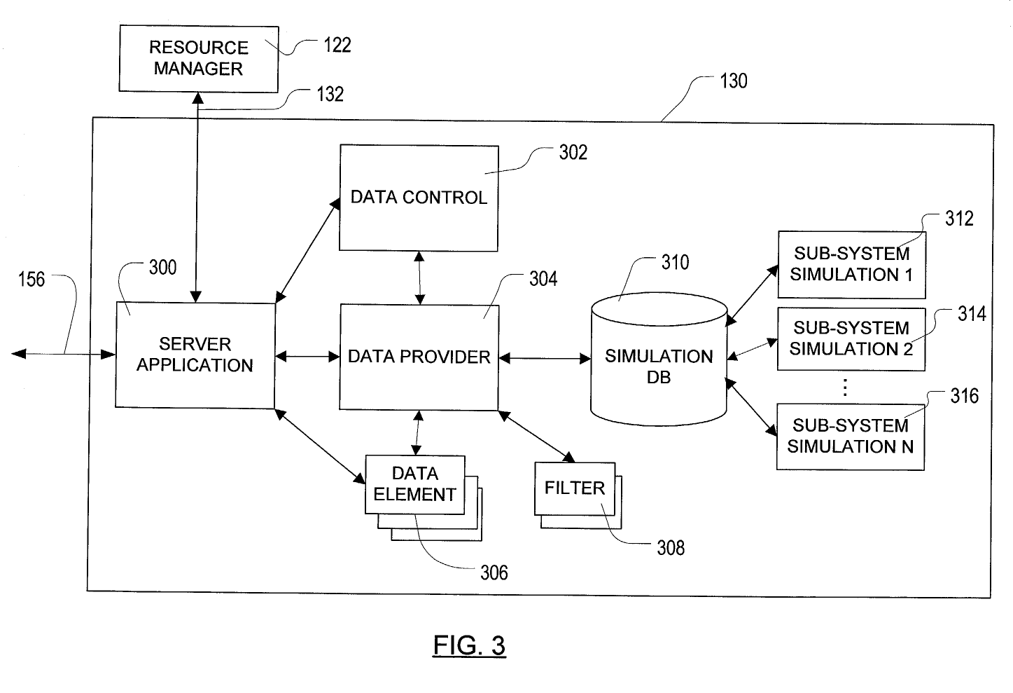

FIG. 3 is a schematic diagram of principal components of a simulation server 130 in accordance with the invention. The simulation server 130 is connected to the resource manager 122 by a bi-directional communications connection 132, as explained above. A server application 300 communicates with the resource manager 122 when an instance of the simulation server 130 is reserved, as explained above. The server application 300 also communicates via direct connection 156 to the client computers 108, 110 while a learning session is in progress that requires an instance of the full-scope simulation. While a learning session is in progress, the simulation server receives inputs from the client computer 108 and sends simulation data to the client computer 108.

After the student 112 selects a course as described above with reference to FIG. 2, the RTE 500 of the client computer receives information from the courseware respecting data elements that must be subscribed to, to permit the data exchange between the client computer 108 and the simulation server 130. As will be explained below with reference to FIG. 5, the RTE 500 supervises local creation of the required data elements. A subscription request message for those data elements is then sent to the application server 300 over the direct connection 156. The application server forwards the subscription request to a data control 302. The data control 302 is responsible for selecting a data provider 304 to handle the information exchange, using any suitable selection algorithm. After selecting a data provider 304, the server application 300 sends the subscription request to the data provider 304. The data provider 304 uses the element descriptors in the subscription request to create data elements 306.

As is well known in the art, one way to implement a full-scope simulation is to create a plurality of subsystem simulations 312-316 that simulate all the required sub-systems of the complex system. Each sub-system subscribes to data elements that it continuously writes to, and reads from, a simulation database 160 while the simulation is running, in a manner well known in the art. As will be understood by those skilled in the art, many other methods of providing a full-scope simulation also exist and the invention is equally adapted to use another type of full-scope simulation. The data provider 304 iteratively polls the simulation database 160 for a value of each of the subscribed data elements 306. In order to improve efficiency and ensure that only required data is sent from the server application 300 over direct connection 156 to the client computer, one or more filter functions 308 are used to determine whether a data element has changed sufficiently that it should be forwarded to the RTE 500 of the client computer 108. A filter may also, for example, apply compression techniques in order to minimize the resulting bandwidth usage.

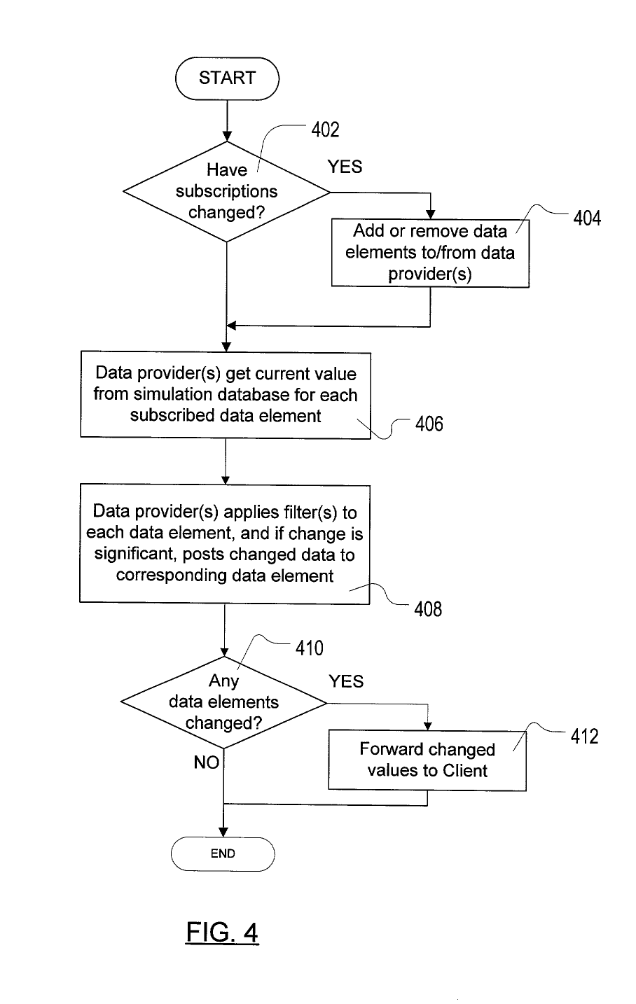

FIG. 4 is a flow chart illustrating an embodiment of a method of sending data updates from the simulation server 130 to the RTE 500 of the client computer 108. In step 402, the data provider 304 determines whether the subscriptions to data elements 306 have changed. The subscriptions are subject to change as, for example, the high-resolution graphical representation of the complex system displayed to the student 112 is panned or scrolled, or the courseware displays some other portion of the complex system during the course that the student 112 is following. If any of the subscriptions to the data elements have changed, the data elements 306 are added or removed by the data provider 304, as required (step 404). The data provider 304 then polls the simulation database 160 (FIG. 3) to retrieve a current value for each data element 306, as described above. The data provider 304 then applies one or more filters 308 to each data element value to determine if the value has changed significantly since it was last sent to the RTE 500 of the client computer 108, or to apply other bandwidth reducing algorithms.

As will be understood in the art, any number of algorithms can be used to apply filters 308. In accordance with one embodiment of the invention, each data element 306 is assigned to a class. Each data element 306 may belong to one and only one class, but the number of data elements in a class is not limited. Associated with each class are one or more filters 308. Consequently, when a data provider 304 retrieves a value for a data element 306 from the simulation database 160, the data provider 304 determines the class of the data elements using a class table (not shown), and uses filter(s) associated with the class to determine whether a difference between a value stored in data element 306 (last reported value) is “significant” when compared with the value just retrieved from the simulation database 310. If the filters determine that the change is significant, the data provider 304 writes the new value retrieved from the simulation database 160 to the data element 306 and, for example, sets a changed value flag. Meanwhile, the application server 300 determines whether any data elements have changed by, for example, inspecting the changed value flag. If so, the application server 300 forwards the changed values to the client computer 108 (step 412) and resets the changed value flag. This process reiterates until the course is completed, at which time the connection with the instance of the simulation server is terminated, as explained above with reference to FIG. 2.

FIG. 5 is a schematic diagram of a thin client installed on the client computer 108 shown in FIG. 1. As explained above, the thin client includes a run-time engine (RTE) 500 which serves as a principal engine for the thin client in accordance with the invention. As also explained above, when a course is selected, the run-time engine 500 determines the list of data elements which must be subscribed to dynamically at runtime based on viewable content and upon view changes thereafter, to receive required updates from the simulation server 130 in order to support the high-resolution graphical displays of the complex system required by the courseware. When the RTE 500 determines the list, or dynamically determines changes to the list, it passes the data element subscription request to data control 502. Data control 502 selects an available remote data provider 504 using an appropriate algorithm as explained above with reference to FIG. 3. The remote data provider in turn creates the required data elements 506. After the data elements 506 are created, the remote data provider 504 forwards the subscription request to the server application 150 over the direct connection 156, as also explained above. Thereafter, when data updates are received by the client computer 108, the remote data provider 504 writes the new data values to data elements 506 and the run-time engine 500 reads the new values for changed data elements 506 and forwards the changed values to appropriate drivers in the user interface 508 to update the high-resolution graphical representations to indicate the change in condition of the simulation of the complex system to the student 112.

Since the courseware in accordance with the invention runs over a full-scope complex system simulation, it is possible for a student to destabilize the simulation, which is undesirable because it may interrupt the flow of the courseware and have other undesirable consequences. Consequently, the courseware that runs on the thin client filters inputs by the student 112 to ensure that they are acceptable in the context of the courseware. As shown in FIG. 6, the RTE 500 waits for input from the student (step 600). When input is received, the RTE 500 first determines whether the session has ended (step 601) and exits if it has. Otherwise, the RTE 500 determines whether the filter is on (step 602). If the filter is not on, the student is in free-play mode and the input is passed to the data control 502, remote data provider 504 and on through network 104 to the instance of the simulation.

If it is determined in step 602 that the filter is on, the student is in guided practice, practice or evaluation mode. Consequently, data control 502 permits courseware running on the RTE 500 to validate the input from the student 112. The courseware will validate the input in accordance with rules established by an author of the courseware, who authored the courseware using an authoring tool as described in Applicant's copending patent application entitled METHOD AND APPARATUS FOR SELF-PACED INTEGRATED PROCEDURE TRAINING USING A REAL-TIME, FULL-SCOPE SIMULATION, filed concurrently herewith, the specification of which is incorporated herein by reference.

If it is determined in step 606 that the client interaction is permitted, the value is sent to the simulation by the remote data provider 504 (step 608). Otherwise, the courseware may request remedial action of the student 112 (step 610), for example by displaying an error message or suggesting a course of action, and the process returns to step 600. Thus, the student may be guided through the training session and acquires the knowledge imparted by the integrated procedure training session.

As will be understood by those skilled in the art, embodiments of the invention described above represent only one possible implementation of the invention. The scope of the invention is therefore intended to be limited solely by the scope of the appended claims.

We claim:

1. A system for enabling distance learning that permits a student to use a remote client computer connected to a network to learn systems knowledge and integrated procedures, the system comprising:
at least one simulation server adapted to instantiate an instance of a real-time, full-scope simulation of a complex system for a learning session initiated by the student, to receive from the remote client computer, inputs generated by an interaction of the student during the learning session, and to pass the inputs to the instance, and further adapted to receive outputs from the instance and to pass the outputs to the remote client computer, which updates a graphical user interface displayed by the remote client computer to reflect a condition of the instance while the student trains.

2. A system as claimed in claim 1 further comprising a session manager adapted to control and regulate access to the full-scope simulation.

3. A system as claimed in claim 1 further comprising self-paced courseware to facilitate the student training.

4. A system as claimed in claim 3 further comprising a session manager adapted to control and regulate access to courseware on full scope simulation and other systems knowledge and integrated procedure learning services available through the system.

5. A system as claimed in claim 3 further comprising a learning management system adapted to maintain student training records and student evaluation data.

6. A system as claimed in claim 4 further comprising a courseware server adapted to store the self-paced courseware, and to serve the self-paced courseware to the RTE of the remote client computer when a student using the remote client computer selects a courseware module for the self-paced learning.

7. A system as claimed in claim 1 further comprising a resource manager adapted to allocate simulation resources to remote client computers and to track simulation usage by students.

8. A system as claimed in claim 1 further comprising a client component that runs on the remote client computer, the client component including a run-time engine (RTE), a remote data provider and a remote data control.

9. A system as claimed in claim 8 wherein the courseware is adapted to examine data inputs generated by interaction of the student with the user interface of the remote client computer, and to pass the data inputs to the remote data provider only if the inputs are acceptable to the courseware.

10. A system as claimed in claim 9 wherein the courseware is further adapted to request remedial action of the student if the input is not acceptable to the courseware.

11. A system as claimed in claim 1 wherein the instance of the simulation server further comprises a data control adapted to select a simulation data provider.

12. A system as claimed in claim 11 wherein the simulation data provider is adapted to retrieve data element values from the instance that are subscribed to by the remote data provider, and further adapted to determine whether the outputs are to be forwarded to the RTE.

13. A system as claimed in claim 11 further comprising a direct connection between at least one simulation server and the network.

14. A method of providing distance learning to a student having remote client computer connected to a network, comprising steps of:
providing a server component connected to the network to permit the student to initiate a learning session;
adapting a real-time, full-scope simulation for simulating the complex system to instantiate an instance of the simulation for the learning session; and
providing an interface between the instance of the simulation and the run-time engine running on the remote client computer, to permit a graphical user interface to be displayed to the student to be dynamically updated to reflect a condition of the instance of the simulation.

15. A method as claimed in claim 14 further comprising a step of providing self-paced courseware for the purpose of learning systems knowledge and integrated procedures associated with the simulation of the complex system.

16. A method as claimed in claim 14 further comprising a step of:
providing a remote client component that is installed on the remote client computer, the remote client component including a run time engine adapted to receive simulation data from the instance of the simulation and to update the display of the graphical user interface in response to receipt of the simulation data.

17. A method as claimed in claim 14 further comprising a step of:
connecting the server component to the Internet; and
providing an interface for the server component to permit the student to initiate the learning session through the Internet.

18. A method as claimed in claim 14 further comprising a step of:
providing a learning management system associated with the server component, for tracking students and storing courseware and performance data associated with the student.

19. A method as claimed in claim 14 further comprising a step of providing a session manager associated with the server component, for ensuring that only qualified students have access to the courseware and/or the simulation.

20. A method of enabling a student to learn systems knowledge and integrated procedures associated with a complex system from a remote location, comprising steps of:
accepting a learning session initiation request from a client computer operated by the student;
validating that the student is registered to use the simulation;
requesting the full-scope simulation to instantiate an instance of the simulation for the learning session; and
establishing a connection between the client computer and the instance of the full-scope simulation to permit actions of the student to be reflected in a condition of the full-scope simulation as the student learns.

21. A method as claimed in claim 20 further comprising a step of accepting a courseware selection from the student to permit the student to learn using the courseware.

22. A method as claimed in claim 20 wherein the step of establishing a connection further comprises steps of:
sending an address of the instance of the full-scope simulation to a run time engine that operates on the client computer; and
accepting a connection request from the run time engine at the instance of the full-scope simulation to establish a direct connection between the full-scope simulation and the client computer to permit data to be exchanged directly between the instance and the run time engine.

23. A method as claimed in claim 20 further comprising steps of:
prior to sending data from the instance of the full-scope simulation to the run time engine, examining the data to ensure that the data represents a significant change in a graphical user interface displayed by the client computer; and
sending the data only if it is determined that the data represents a significant change in the graphical user interface.
sending the data in a manner that is optimal in bandwidth usage.

24. A method as claimed in claim 21 further comprising a step of prior to sending data from the client computer to the instance of the full-scope simulation, examining the data to ensure that the data is acceptable to the courseware before the data is sent.

25. The method as claimed in claim 24 wherein if the data is not acceptable to the courseware, the method further comprises a step of operating the courseware to request remedial action of the student.

26. A method as claimed in claim 22 wherein the step of passing the address further comprises a step of encrypting the address before the address is sent to the run time engine.

27. A method as claimed in claim 21 wherein the step of requesting is preceded by a step of selecting a simulation to match the courseware selected by the student.
